(19) United States
(12) Patent Application Publication
(10) Pub. No.: US 2005/0012477 A1
(43) Pub. Date: Jan. 20, 2005

(54) JBOX and safety zone PIR system

(76) Inventors: Joseph M. Piana, Riverview, FL (US); Mohammad Karaki, Boynton Beach, FL (US)

Correspondence Address: Vincent L. Ramik;DILLER, RAMIK & WIGHT, Suite 101, 7345 McWhorter Place, Annandale, VA, 22003, US

(21) Appl. No.: 10/621,336

(22) Filed: Jul. 18, 2003

(51) Int. Cl. H02P 1/54

(52) U.S. Cl. 318/109

(57) ABSTRACT

A universal junction box for controlling the operations of an adjustable bed is disclosed. A microprocessor and control logic drive a plurality of motors based on received command signals to adjust the position of the adjustable bed. A universal power supply receives power from a source and converts the power to appropriate voltage levels to power the microprocessor and control logic and motors, wherein the universal power supply has automatic sensing for sensing the voltage of the source. A programmable RF receiver receives command signals from a remote control, wherein the RF receiver recognizes any remote operating in a predetermined frequency range.

### FIELD OF THE INVENTION

The invention relates to control of an adjustable bed, and more particularly to a universal junction box and associated devices for controlling the operations of an adjustable bed.

### BACKGROUND OF THE INVENTION

Adjustable beds have a variety of modes of operation which can place the adjustable bed in a variety of positions. For example, the head of the bed can be raised or lowered and the end of the bed where a persons feet are located can be manipulated to raise or lower the upper and lower parts of the persons legs. In addition, the bed can be vibrated to message the user. All of these operations are controlled by a control system and can be requested by the user via a hardwired or wireless remote control. The control system connected to the bed and associated devices such as drivers and motors receives these requests and causes various motors to move the bed as requested.

A number of control units for controlling the operations of an adjustable bed are known. These control units are programmed during manufacture with specific software which controls the operation of the adjustable bed. However, these known control units have several disadvantages.

For example, these known control units have set channels on which they recognize commands from a wireless remote control. This can lead to problems when the user finds a different remote control that they would like to use to control the operations of the bed, but are unable to use because the control unit can not recognize the commands from the new remote control unit because the new remote control operates on a different channel.

Another disadvantage of known control units is that the known control units are manufactured to operate on 115-130 VAC (for use in the United States) or for 215-230 VAC (for use in foreign counties). This is a disadvantage for control unit manufacturers with respect to inventory control. For example, the manufacturer may have to rewire some domestic in-stock models to be sold in a foreign country to fulfill an order when inventory of the foreign models is low. This rewiring process costs the manufacturer both time and money.

Thus, there is a need for a novel control unit for controlling the operations of an adjustable bed which overcomes at least the disadvantages of known control units described above.

### SUMMARY OF THE INVENTION

According to one embodiment of the invention, a universal junction box for controlling the operations of an adjustable bed is disclosed. A microprocessor and control logic drive a plurality of motors based on received command signals to adjust the position of the adjustable bed. A universal power supply receives power from a source and converts the power to appropriate voltage levels to power the microprocessor and control logic and motors, wherein the universal power supply has automatic sensing for sensing the voltage of the source.

According to one embodiment of the invention, a universal junction box for controlling the operations of an adjustable bed is disclosed. A microprocessor and control logic drive a plurality of motors based on received command signals. A programmable RF receiver receives command signals from a remote control, wherein the RF receiver recognizes any remote operating in a predetermined frequency range.

According to another embodiment of the invention, an adjustable bed is disclosed. The adjustable bed comprises an adjustable mattress and an actuator for adjusting the position of the mattress. An enclosed bed frame supports the adjustable mattress, and a detection system detects the presence of a human or animal inside the enclosed bed frame.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 illustrates an adjustable bed assembly according to one embodiment of the invention.

FIG. 2 is a block diagram of a control system for controlling an adjustable bed according to one embodiment of the invention.

FIG. 3 is a block diagram of a universal junction box and associated equipment according to one embodiment of the invention.

FIG. 4 is illustrates an adjustable bed assembly according to one embodiment of the invention.

FIGS. 5(a)-(e) illustrate various views of a passive infra red detector according to another embodiment of the invention.

### DETAILED DESCRIPTION OF THE INVENTION

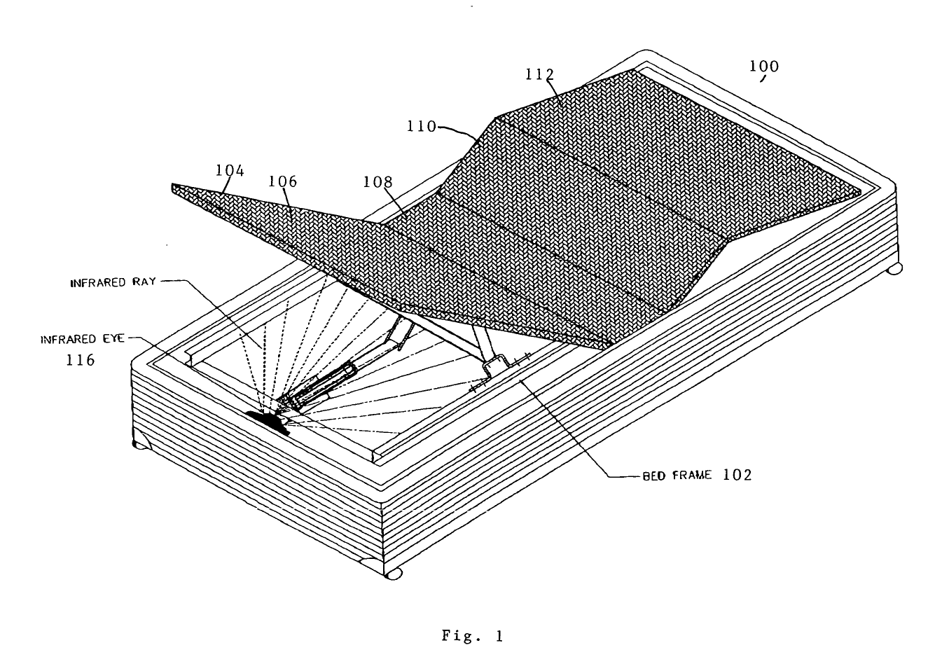

An adjustable or articulated bed 100, according to one embodiment of the invention, is illustrated in FIG. 1. The adjustable bed 100 comprises, among other features, an adjustable bed frame 102 upon which rests a mattress 104 of a conventional construction, including a back rest mattress portion 106, a seat mattress portion 108, a thigh mattress portion 110, and a leg mattress portion 112. The mattress 104 can be moved between a substantially horizontally disposed position (not shown) and an adjusted or articulated position as illustrated in FIG. 1. The adjustable bed 100 and the adjustable bed frame 102, including the mechanisms 114 for moving the adjustable frame 102, are preferably constructed and arranged in accordance with the details of U.S. Pat. No. 6,276,011, granted on Aug. 21, 2001 to Santino Antinori. The adjustable bed also has a passive infra red detector system 116, for ensuring that a person or animal is not trapped when the adjustable bed is lowered.

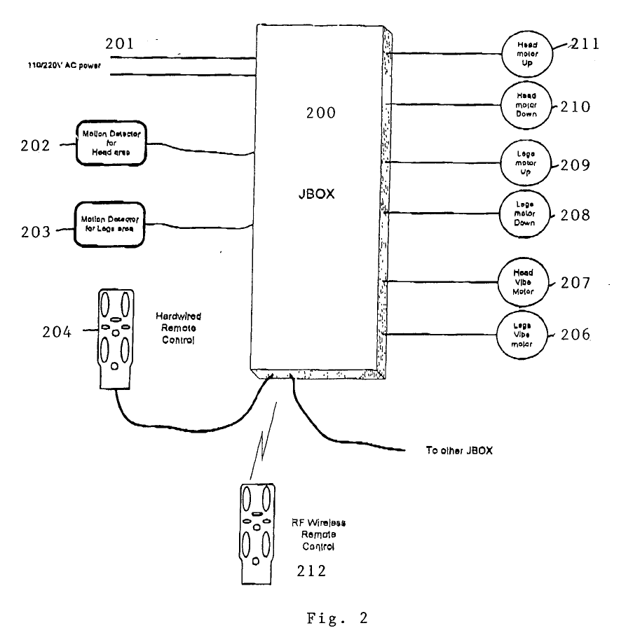

The adjustable bed 100 is controlled by a universal junction box 200 and associated devices as illustrated in FIG. 2. The universal junction box 200 receives AC power from an external power source 201. The AC power is switched ON and OFF to control a head up motor 211, a head down motor 210, a leg up motor 209, and a leg down motor 208 upon user request. In addition, the power sent to a head vibration motor 207 and a leg vibration motor 206 is pulse width modulated in a known manner to vary their speed and strength according to the user's request.

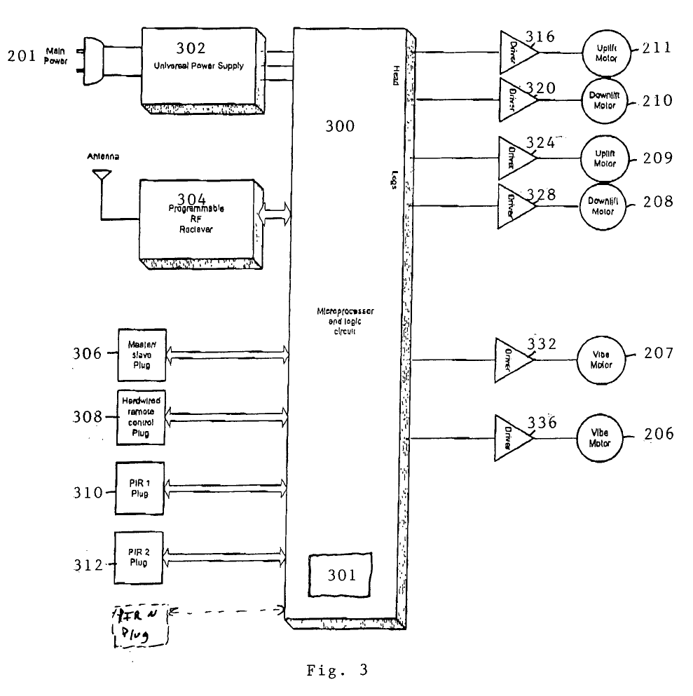

The universal junction box 200 can receive user commands via an RF wireless remote control 212 and/or a hardwired remote control 204. As noted in FIG. 1, the universal junction box 200 is also connected to a safety detection system 202 and 203 which is located in the head and foot area of the adjustable bed 100. As will be explained below in more detail with respect to FIG. 3, the universal junction box 200 can be connected to a second junction box (not illustrated) so that two beds connected together will act as a singe bed.

FIG. 3 illustrates one embodiment of the universal junction box and associated devices which are used to control an adjustable bed. The universal junction box 200 is controlled by a microprocessor and associated logic control circuits 300. A suitable microprocessor for use in the invention is a Texas Instruments microcontroller, model number MSP 430F1351PM, but the invention is not limited thereto. The control logic circuits include, among other devices, memory circuits for storing the necessary software programs needed to properly operate the universal junction box 200. According to one embodiment of the invention, the logic control circuits include, among other circuits, a flash memory chip 301 which enables a manufacturer to make on the fly changes and universal junction box enhancements without the need for board reconfigurations and redesign. This is accomplished by downloading new control and operational software into the flash memory 301 from an external source whenever an upgrade or change becomes available.

As described above, the universal junction box 200 can receive and operate using power sources with different power levels. This is accomplished by routing the incoming power to a universal power supply 302. The universal power supply 302 is an internal switching power supply with automatic voltage sensing. The universal power supply senses the voltage from the power source 201 and switches internally to the determined voltage without user intervention. The universal power supply 302 allows the universal junction box 200 to accept voltages which range from 90V-260V at either 50 Hz or 60 Hz. Thus, the universal junction box 200 has the ability to be used in a multitude of different countries without the need for user or manufacturer intervention with respect to the voltage of the input power supply. A suitable universal power supply for use in the invention is a HI CAL transformer, model SIL 6004, but the invention is not limited thereto.

The input AC power is converted by the universal power supply 302 to low voltage levels which is used to power the microprocessor and logic control circuits 300. In addition, the microprocessor and logic control circuits 300 control the power which is applied to a series of drivers 316, 320, 324, 328 to control the motors 208-211 which adjust the positions of the various sections of the adjustable bed 100. When a specific adjustment has been requested by a user, the control logic circuits 300 apply power to the specific drivers 316, 320, 324, 328 to drive the motors required to perform the specific request. In addition, the microprocessor and logic control circuits 300 control the power provided to drivers 332 and 336 to control the leg and head vibration motors 206 and 207, respectively. The power to the vibration motors 206 and 207 is pulse width modulated to vary their speed and strength depending on the user's request.

According to one embodiment of the invention, the microprocessor and logic control circuits 300 have inputs 308 and 304 for a wired remote control 204 and a wireless remote control 212, respectively. These remote controls allow the user to control the motors 206-211 as the user wishes. The wireless remote control input 304 is a programmable RF receiver. The programmable RF receiver 304 allows the universal junction box 200 to recognize any remote control which operates in the RF frequency range. For example, the RF receiver 304 can be programmed by the microprocessor 300 to receive RF signals which range between approximately 418 MHz and 433 MHz but the invention is not limited thereto. This allows the universal junction box 200 to universally accept commands from multiple remote controls that operate on different frequencies. A suitable RF receiver for use in the invention is a CHIPCON IC RF transceiver, model number CC 1000, but the invention is not limited thereto.

The universal junction box 200 “learns” the operating frequency of the remote control the first time a button is pressed or activated on the remote control. The ability to learn the operating frequency of the remote control eliminates the need for setting the accepted RF frequency for a remote control during manufacture of the universal junction box. By allowing the universal junction box 200 to recognize a multitude of remote controls, the individual user is able to select a remote control which suits their personal preferences. The user has the ability to switch between different models of remote control devices by simply unplugging the universal junction box from the power supply and then reconnecting the power supply, wherein the universal junction box will relearn the next remote control on which a button is pressed.

The universal junction box 200 also has a master/slave plug 306 which allows two universal junction boxes to be connected together via a telephone wire so that their operations are coordinated. For example, two extra long twin beds can be situated side by side and operated simultaneously as a single king size bed by connecting the universal junction boxes of each twin bed together using the master/slave plug 306 on each box. The two universal junction boxes communicate and/or negotiate with each other to notify each that it is being used in a primary/secondary configuration.

According to another embodiment of the invention, the universal junction box 200 has a plurality of plugs 310, 312 for receiving signals from a safety detection system associated with the adjustable bed 100. While the universal adjustable bed 200 illustrated in FIG. 3 has 2 plugs for receiving the signals from the detection system, the invention is not limited thereto and the number of plugs which can be used in this embodiment of the invention is one or more.

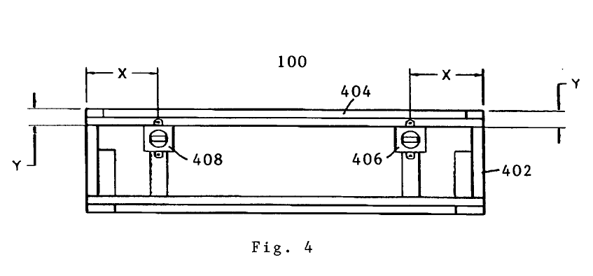

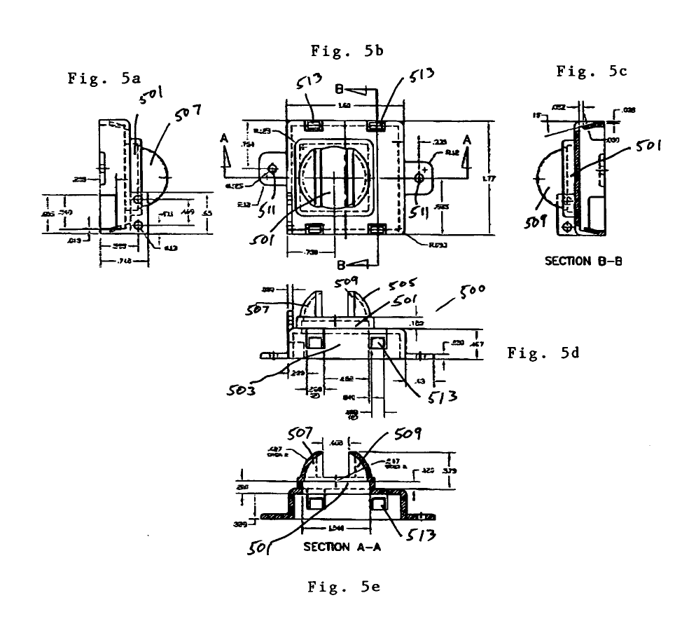

In this embodiment of the invention, the safety detection system is a motion detection system which is used to ensure that the head and/or leg sections of the bed are not lowered from a raised position onto a person or animal. While a passive infra red (PIR) detection system is illustrated in FIGS. 4-5, it will be understood by one skilled in the art that a variety of motion detection systems and other safety systems can be used to ensure that a person or animal is not trapped or caught by the mattress being lowered and the invention is not limited thereto.

FIG. 4 illustrates the view from inside an adjustable bed frame 402 looking toward either end of the bed. In this illustrative example, the adjustable mattress 404 is in a closed or horizontal position. Two passive infra red detectors 406, 408 are mounted at the end of the adjustable bed and at the foot of the adjustable bed (not illustrated). The two passive infra red detectors 406 and 408 are mounted on the bed frame 402 inside the area defined by the bed frame 402 and the mattress 404, but the invention is not limited thereto.

Each passive infra red detector 500 comprises, among other elements, a pyroelectric sensor 503 and a frensel lens 501. The frensel lens 501 produces an infra red ray which is inherently a 160 degree omni directional with a 5 foot limit. The visibility of the pyroelectric sensor 503 is confined to the enclosure through the unique design of the passive infra red enclosure 505 and the placement of the detector 500 within the frame of the adjustable bed. The plastic enclosure 505 limits the visibility of the pyroelectric sensor in the vertical plane, by deflecting the beam at a rate of 3 degrees vertically via flanges 507 and 509. The placement of the detector 500 inside the enclosed bed frame limits the horizontal beam enabling the PIR system to detect only an animal or human entering the enclosure itself and ignoring any person or animal outside the box. The passive infra red detector 500 can be attached to a bed frame using screws, nails, etc, via holes 511. In addition, the passive infra red enclosure 505 is removeably attached to the detector 500 via attachments 513. Preferred placement measurement for various sized beds are illustrated in Table 1, however the invention is not limited thereto.

| Bed Size | X (in) | Tolerance | Y (in) | Tolerance (in) |
|---|---|---|---|---|
| Twin | 4.50 | +/−.50 | 1.50 | +/−.375 |
| 36 × 84 | 6.50 | +/−.50 | 1.50 | +/−.375 |
| Full | 11.75 | +/−.50 | 1.50 | +/−.375 |
| Queen | 15.25 | +/−.50 | 1.50 | +/−.375 |
| Olym/Queen | 15.25 | +/−.50 | 1.50 | +/−.375 |

During either a head or leg lowering operation, the pyroelectric sensor 503 senses temperature changes caused by objects in the infra red rays projected from the frensel lens. The detection system monitors the temperature variations and determines whether the temperature variations are greater than a predetermined level. For example, the predetermined temperature variation may be set to 4° Celsius ambient temperature change but the invention is not limited thereto. If the temperature variations are greater than the predetermined level, it is assumed that a person or animal or at least a part of a human or animal (head, hand, leg, etc.) is within the detection area. If it is determined that the temperature variation is greater than the predetermined level, the detection system 500 sends a signal to the microprocessor 300. When the microprocessor 300 receives the signal from one of the detectors 500, the microprocessor 300 turns the power off to either the head down motor 210 and/or leg down motor 208. The microprocessor 300 then directs power to be supplied to either the head up motor 211 and/or the leg up motor 209 for a predetermined period of time, for example 4 seconds and/or until the mattress reaches a maximum elevation.

It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims.

1. A universal junction box for controlling the operations of an adjustable bed comprising:
microprocessor and control logic for driving a plurality of motors based on received command signals to adjust a position of the adjustable bed; and
a universal power supply for receiving power from a source and converting the power to appropriate voltage levels to power the microprocessor and control logic and motors, wherein the universal power supply has automatic sensing for sensing the voltage of the source.

2. The universal junction box according to claim 1, wherein the universal power supply accepts voltages from the source between approximately 90 V and 260 V.

3. The universal junction box according to claim 1, further comprising:
connection means for connecting two universal junction boxes together so that the two universal junction boxes operate in a master/slave configuration.

4. The universal junction box according to claim 1, further comprising:
a flash memory for receiving and storing operational software for said universal junction box from an external source.

5. The universal junction box according to claim 1, further comprising:
connection means for connecting the universal junction box to at least one detection system mounted on a frame for said bed for detecting the presence of a human or animal inside said frame.

6. The universal junction box according to claim 5, wherein at least two detection systems are mounted on the frame, at least one at each end of the frame.

7. The universal junction box according to claim 5, wherein the detection system comprise a pyroelectric sensor and a light source with a frensel lens.

8. The universal junction box according to claim 7, wherein the detection system further comprises an enclosure for limiting the visibility of the sensor in the vertical plane.

9. The universal junction box according to claim 5, wherein the detection system detects the presence of a human or animal by detecting an ambient temperature change inside the enclosed frame.

10. A universal junction box for controlling the operations of an adjustable bed, comprising:
microprocessor and control logic for driving a plurality of motors based on received command signals; and
a programmable RF receiver for receiving command signals from a remote control, wherein the RF receiver recognizes any remote operating in a predetermined frequency range.

11. The universal junction box according to claim 10, wherein the frequency range is between 418 MHz and 433 MHz.

12. The universal junction box according to claim 10, wherein the universal junction box determines the operating frequency of a remote when a button on the remote is activated.

13. The universal junction box according to claim 10, further comprising:
connection means for connecting two universal junction boxes together so that the two universal junction boxes operate in a master/slave configuration.

14. The universal junction box according to claim 10, further comprising;
a flash memory for receiving and storing operational software for said universal junction box from an external source.

15. The universal junction box according to claim 10, further comprising:
connection means for connecting the universal junction box to at least one detection system mounted on a frame for said bed for detecting the presence of a human or animal inside said frame.

16. The universal junction box according to claim 15, wherein at least two detection systems are mounted on the frame, at least one at each end of the frame.

17. The universal junction box according to claim 15, wherein the detection system comprise a pyroelectric sensor and a light source with a frensel lens.

18. The universal junction box according to claim 17, wherein the detection system further comprises an enclosure for limiting the visibility of the sensor in the vertical plane.

19. The universal junction box according to claim 15, wherein the detection system detects the presence of a human or animal by detecting an ambient temperature change inside the enclosed frame.

20. An adjustable bed, comprising:
an adjustable mattress;
an actuator for adjusting the position of the mattress;
an enclosed bed frame for supporting the adjustable mattress; and
a detection system for detecting the presence of a human or animal inside the enclosed bed frame.

21. The adjustable bed according to claim 20, wherein at least two detection systems are mounted on the frame, at least one at each end of the frame.

22. The adjustable bed according to claim 20, wherein the detection system comprise a pyroelectric sensor and a light source with a frensel lens.

23. The adjustable bed according to claim 22, wherein the detection system further comprises an enclosure for limiting the visibility of the sensor in the vertical plane.

24. The adjustable bed according to claim 20, wherein the detection system detects the presence of a human or animal by detecting an ambient temperature change inside the enclosed frame.
